(19) United States
(12) Patent Application Publication
(10) Pub. No.: US 2016/0360084 A1
(43) Pub. Date: Dec. 8, 2016

(54) Method and Apparatus for Controlling Photographic Fill-In Light and Terminal

(71) Applicant: HUAWEI DEVICE CO., LTD., Shenzhen (CN)

(72) Inventor: Wenlong Zhao, Beijing (CN)

(21) Appl. No.: 15/117,685

(22) PCT Filed: Feb. 26, 2014
(86) PCT No.: PCT/CN2014/072542

§ 371 Date: Aug. 9, 2016

(51) Int. Cl. H04N 5/235; H04N 5/232; H04N 5/225

(52) U.S. Cl. CPC H04N 5/2354; H04N 5/2256; H04N 5/23293; H04N 5/2351; H04N 5/2253

(57) ABSTRACT

A method for controlling photographic fill-in light is provided. The method includes acquiring illuminance of a photographed object in response to an operation of a user, determining that the illuminance of the photographed object is less than a set threshold, and controlling, when a photographing instruction to photograph the photographed object is received, a display on the terminal to add, in a set manner, light to the photographed object. the photographing apparatus and the display are located on a same side of the terminal.

### CROSS-REFERENCE TO RELATED APPLICATIONS

This patent application is a national phase filing under section 371 of PCT/CN2014/072542, filed Feb. 26, 2014 which is incorporated herein by reference in its entirety.

### TECHNICAL FIELD

The present invention relates to the field of object imaging technologies, and in particular, to a method and an apparatus for controlling photographic fill-in light and a terminal.

### BACKGROUND

A picture taken at low illuminance has a lot of noise and grainy pixels and is indistinct. Even if a digital processing technology for color enhancement is used, an improvement is still limited. For a photographing apparatus, for example, a rear-facing camera, used for common photographing, on a terminal such as a mobile phone or a tablet computer, there is usually a strobe light, so that a problem that a picture shot at low illuminance is indistinct can be improved to a great extent. However, a photographing apparatus, for example, a front-facing camera, that is mainly used for taking a self-portrait photograph is not configured with a strobe light and is generally disposed on a same side as a display. In a case of low illuminance with dim light, a desirable effect cannot be achieved by using the front-facing camera.

### SUMMARY

Embodiments of the present invention provide a method and an apparatus for controlling photographic fill-in light and a terminal, so as to improve a photographing effect of a photographing apparatus on a terminal at low illuminance.

According to a first aspect, a method for controlling photographic fill-in light is provided, including acquiring illuminance of a photographed object in response to an operation of a user, where the operation of the user requests a photographing apparatus of a terminal to take a picture of the photographed object, determining that the illuminance of the photographed object is less than a set threshold, and controlling, when a photographing instruction to photograph the photographed object is received, a display on the terminal to add, in a set manner, light to the photographed object. The photographing apparatus and the display are located on a same side.

In a first possible implementation manner, the controlling a display on the terminal to add, in a set manner, light to the photographed object includes controlling an entire display area or a partial display area of the display to add the light to the photographed object.

With reference to the first possible implementation manner of the first aspect, in a second possible implementation manner, the light added to the photographed object includes white light.

With reference to the first aspect, in a third possible implementation manner, before the controlling a display on the terminal to add, in a set manner, light to the photographed object, the method further includes acquiring an ambient light color of the photographed object, and confirming that the ambient light color of the photographed object is colorful. The controlling a display on the terminal to add, in a set manner, light to the photographed object includes controlling the display on the terminal to add, in a manner of a color complementary to the ambient light color of the photographed object, the light to the photographed object.

With reference to the first aspect, in a fourth possible implementation manner, after the determining that the illuminance of the photographed object is less than a set threshold and before a photographing instruction to photograph the photographed object is received, the method further includes controlling a preview image displayed by the display on the terminal to turn into a complementary color.

According to a second aspect, an apparatus for controlling photographic fill-in light is provided, including a first acquiring unit, configured to acquire illuminance of a photographed object in response to an operation of a user, where the operation of the user requests a photographing apparatus of a terminal to take a picture of the photographed object, a determining unit, configured to determine that the illuminance of the photographed object is less than a set threshold, and a first control unit, configured to, when a photographing instruction to photograph the photographed object is received, control a display on the terminal to add, in a set manner, light to the photographed object. The photographing apparatus and the display are located on a same side.

In a first possible implementation manner, the first control unit is specifically configured to control an entire display area or a partial display area of the display to add the light to the photographed object.

With reference to the first possible implementation manner of the second aspect, in a second possible implementation manner, the light added to the photographed object includes white light.

With reference to the second aspect, in a third possible implementation manner, the apparatus further includes a second acquiring unit, configured to acquire an ambient light color of the photographed object, and a confirmation unit, configured to confirm that the ambient light color of the photographed object is colorful. The first control unit is specifically configured to control the display on the terminal to add, in a manner of a color complementary to the ambient light color of the photographed object, the light to the photographed object. With reference to the second aspect, in a fourth possible implementation manner, the apparatus further includes a second control unit, configured to control a preview image displayed by the display on the terminal to turn into a complementary color.

According to a third aspect, a terminal is provided, including an input apparatus, an output apparatus, a memory, and a processor coupled to the memory, where the output apparatus includes a display, and the processor is configured to acquire illuminance of a photographed object in response to an operation of a user, where the operation of the user requests a photographing apparatus of the terminal to take a picture of the photographed object, determine that the illuminance of the photographed object is less than a set threshold, and, when a photographing instruction to photograph the photographed object is received, control the display on the terminal to add, in a set manner, light to the photographed object. The photographing apparatus and the display are located on a same side.

In a first possible implementation manner, the controlling a display on the terminal to add, in a set manner, light to the photographed object includes:

controlling an entire display area or a partial display area of the display to add the light to the photographed object.

With reference to the first possible implementation manner of the third aspect, in a second possible implementation manner, the light added to the photographed object includes white light.

With reference to the third aspect, in a third possible implementation manner, before the step of controlling the display on the terminal to add, in a set manner, light to the photographed object, the processor is further configured to acquire an ambient light color of the photographed object, and confirm that the ambient light color of the photographed object is colorful. The controlling the display on the terminal to add, in a set manner, light to the photographed object includes controlling the display on the terminal to add, in a manner of a color complementary to the ambient light color of the photographed object, the light to the photographed object.

With reference to the third aspect, in a fourth possible implementation manner, after the determining that the illuminance of the photographed object is less than a set threshold and before the photographing instruction to photograph the photographed object is received, the processor is further configured to control a preview image displayed by the display on the terminal to turn into a complementary color.

By means of the technical solutions of the method and the apparatus for controlling photographic fill-in light and the terminal provided in the embodiments of the present invention, when a photographed object is at low illuminance, a display, located on a same side as a photographing apparatus, on a terminal may be controlled to add light to the photographed object, so as to improve a photographing effect of the photographing apparatus.

### BRIEF DESCRIPTION OF THE DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a method for controlling photographic fill-in light according to an embodiment of the present invention;

FIG. 2 is a schematic diagram of taking a self-portrait photograph of a human face by using a front-facing camera of a mobile phone;

FIG. 3 is a flowchart of another method for controlling photographic fill-in light according to an embodiment of the present invention;

FIG. 4 is a schematic diagram of a comparison between preview pictures taken before and after a preview complementary color is used;

FIG. 5a is a schematic diagram of adding white light by using a display of a terminal;

FIG. 5b is a schematic diagram of adding light to a photographed object in different directions by using different pictures displayed on the display of the terminal;

FIG. 6 is a flowchart of still another method for controlling photographic fill-in light according to an embodiment of the present invention;

FIG. 7 is a schematic structural diagram of an apparatus for controlling photographic fill-in light according to an embodiment of the present invention;

FIG. 8 is a schematic structural diagram of another apparatus for controlling photographic fill-in light according to an embodiment of the present invention;

FIG. 9 is a schematic structural diagram of still another apparatus for controlling photographic fill-in light according to an embodiment of the present invention; and

FIG. 10 is a schematic structural diagram of a terminal according to an embodiment of the present invention.

### DETAILED DESCRIPTION OF ILLUSTRATIVE EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

Referring to FIG. 1, FIG. 1 is a flowchart of a method for controlling photographic fill-in light according to an embodiment of the present invention. The method includes the following steps.

Step S101: Acquire illuminance of a photographed object in response to an operation of a user, where the operation of the user requests a photographing apparatus of a terminal to take a picture of the photographed object.

Two photographing apparatuses are generally installed on an existing terminal such as a mobile phone and a tablet computer, where one photographing apparatus is disposed on a same side as a display of the terminal and is generally referred to as a front-facing camera. Generally, there is no strobe light disposed for the photographing apparatus, and in a case of low illuminance, a photographing effect of the photographing apparatus is relatively undesirable. Illuminance is a degree to which an object is illuminated, and specifically, refers to energy of visible light received on a unit area of an object. A street in the dark, a dimly lit room, and the like are generally of low illuminance. If illuminance of a photographed object is relatively low, when the photographed object is photographed by using the photographing apparatus, a picture of the photographed object is indistinct, and an effect is relatively undesirable. Moreover, because a photographing apparatus is located on a same side as a display, a behavior of photographing a photographed object by using the photographing apparatus is generally a behavior of taking a self-portrait photograph.

The user performs an operation on the terminal, for example, opens an application program having a photographing function to request the photographing apparatus of the terminal to take a picture of the photographed object, and the terminal receives the operation of the user, and acquires illuminance of the photographed object in response to the operation of the user. Specifically, to acquire the illuminance of the photographed object, a photoelectric sensor on the terminal may be used to detect the illuminance of the photographed object.

Step S102: Determine that the illuminance of the photographed object is less than a set threshold.

The set threshold of the illuminance is preset in the terminal, and when the illuminance of the photographed object is less than the set threshold, it is determined that the photographed object is at low illuminance.

Step S103: Control, when a photographing instruction to photograph the photographed object is received, a display on the terminal to add, in a set manner, light to the photographed object.

The photographing apparatus and the display are located on a same side.

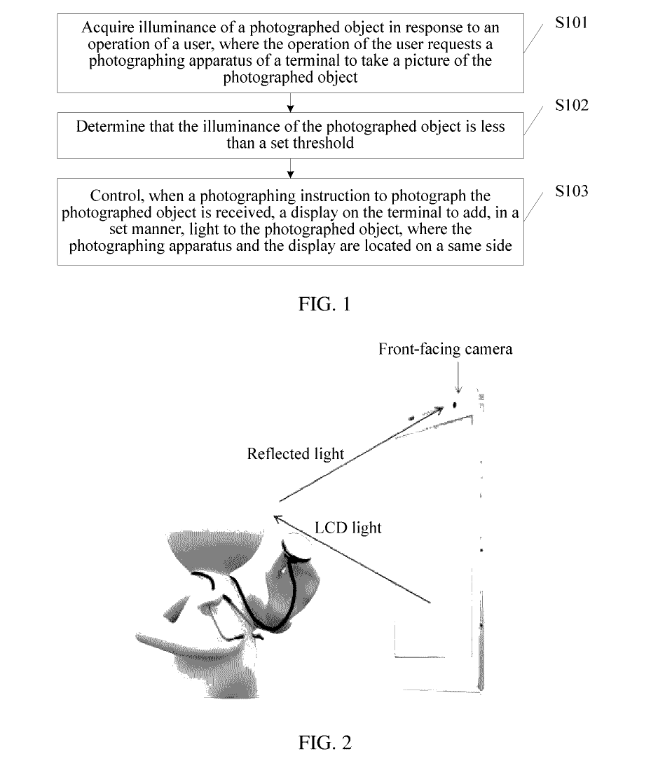

The display on the terminal is generally a liquid crystal display (Liquid Crystal Display, LCD). The LCD is a substance between a solid state and a liquid state and cannot emit light by itself, and with the aid of an additional backlight source, the LCD can emit light. When the photographing apparatus is used for photographing, because the terminal is relatively close to the photographed object, generally, less than 30 cm, light emitted by the LCD may illuminate the photographed object. The display on the terminal is controlled to add, in a set manner, light to the photographed object, so that a photographing effect of the photographing apparatus can be improved. As shown in FIG. 2, light emitted by an LCD screen of a mobile phone illuminates a human face of which a self-portrait photograph is to be taken, and the human face reflects sufficient light to a front-facing camera on the mobile phone, so that a relatively distinct image is formed in the front-facing camera.

Preferably, although in this embodiment of the present invention, a front-facing camera is used as an example for description, and the so-called “front-facing” does not represent a limitation to an application scope of this embodiment of the present invention. A display can be used to add light as long as a camera or a photographing apparatus is located on a same side as the display. Preferably, this embodiment of the present invention may be applied to a scenario in which a camera is not configured with a strobe light. However, this embodiment of the present invention may also be applicable to a scenario in which a strobe light is provided. In this way, with both a strobe light and a display to add light, a photographing effect is more desirable.

It can be seen that, according to the method for controlling photographic fill-in light provided in this embodiment of the present invention, when a photographed object is at low illuminance, a display, located on a same side as a photographing apparatus, on a terminal may be controlled to add light to the photographed object, so as to improve a photographing effect of the photographing apparatus.

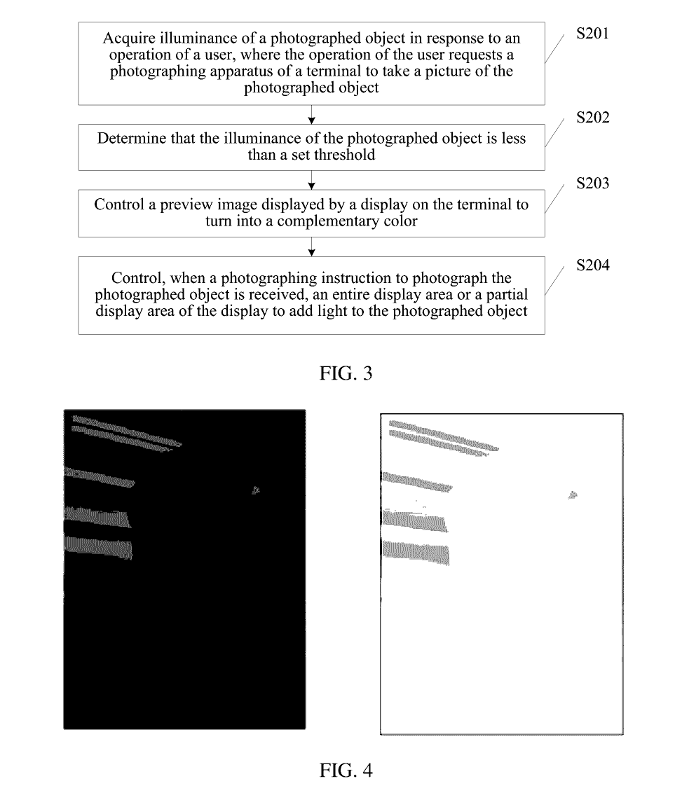

Referring to FIG. 3, FIG. 3 is a flowchart of another method for controlling photographic fill-in light according to an embodiment of the present invention. The method includes the following.

Step S201: Acquire illuminance of a photographed object in response to an operation of a user, where the operation of the user requests a photographing apparatus of a terminal to take a picture of the photographed object.

Step S202: Determine that the illuminance of the photographed object is less than a set threshold.

Implementation processes of step S201 and step S202 are respectively the same as those of step S101 and step S102 in the foregoing embodiment, and details are not described herein again.

Step S203: Control a preview image displayed by a display on the terminal to turn into a complementary color.

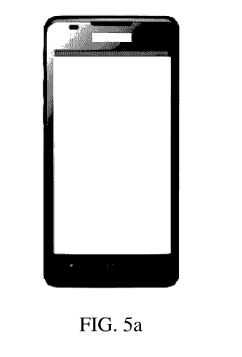

Before formal photographing is performed by using the photographing apparatus on the terminal, generally, a preview image of the photographed object is previewed on the display of the terminal. However, as shown in the left figure of FIG. 4, at low illuminance, because light is weak, the preview image is usually dark. A user of the terminal cannot accurately see the preview image clearly and therefore cannot determine an image composition situation of the photographed object, resulting in a case in which the photographed object, for example, a human face, is not in the middle of an image. When it is determined that the illuminance of the photographed object is less than a set threshold, a preview image displayed by the display on the terminal may be controlled to turn into a complementary color. Because before being turned into a complementary color, a photographed preview image is dark, and after being turned into the complementary color, a preview image is displayed to be approximately white, the photographed object can be illuminated, so that the user can clearly see image composition of the photographed object from the preview image.

A specific principle is as follows: In a case of low illuminance, for example, a user of a terminal takes a self-portrait photograph, in a self-portrait photograph mode, a preview complementary color is enabled. In this case, after being turned into a complementary color, a main image of an LCD becomes white, and light of the LCD illuminates a face of a person taking the self-portrait photograph. Because energy of the light of the LCD is limited, only the face, which is at a relatively short distance, of the person taking the self-portrait photograph can be illuminated, but a background, which is at a relatively long distance, of the image cannot be illuminated. Therefore, an actual image becomes a picture having a bright human face and a black background. In this case, in the complementary color, the background is still white, but the human face becomes grey relatively. The human face in such an image has very high recognition, so that the person taking the self-portrait photograph can easily recognize the human face and compose the image according to the person's own idea, for example, a preview picture, which is taken after a manner of a preview complementary color is used, shown in the right figure of FIG. 4.

An image signal processing (Image Signal Processing, ISP) module is integrated in all existing terminal platforms; therefore, for an effect of a preview complementary color, an ISP parameter may be directly set, and a backlight source is controlled to emit light according to the set ISP parameter to implement a complementary color. A method for specifically setting the ISP parameter belongs to the prior art, and details are not described herein again.

Step S204: Control, when a photographing instruction to photograph the photographed object is received, an entire display area or a partial display area of the display to add light to the photographed object.

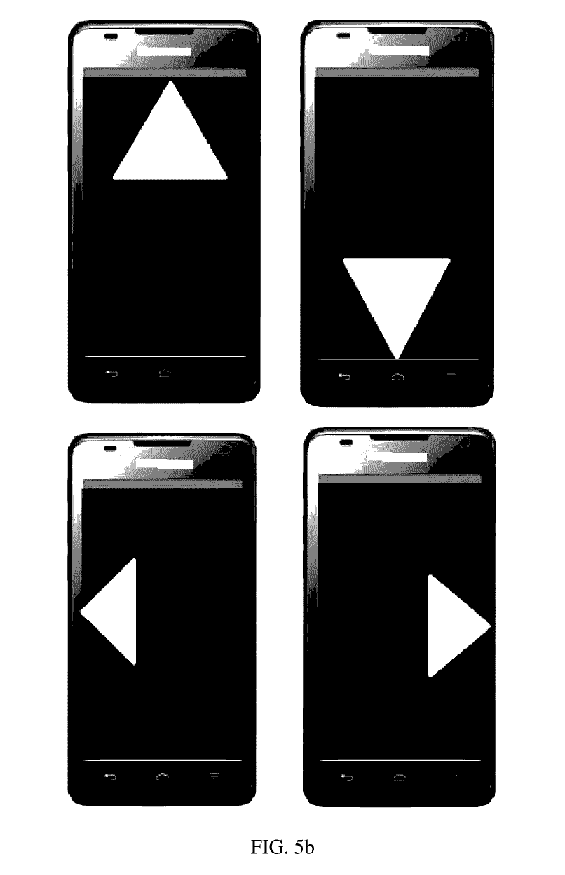

When formal photographing is performed on the photographed object, an entire display area or a partial display area of the display may be controlled to add light to the photographed object. The entire display area of the display is controlled to add light, for example, white light may be added. For example, as shown in FIG. 5a, an LCD display of a mobile phone is used to add pure white light. Light rays emitted by a pure white LCD display are the strongest and an area, which is illuminated by the pure white LCD display, of the photographed object is the largest. The partial display area of the display is controlled to add light. For example, as shown in FIG. 5b, because the LCD display of the mobile phone may be further controlled to display different pictures, the LCD display is controlled to display four different pictures shown in FIG. 5b, thereby implementing adding light to the photographed object in different directions of the top, bottom, left, and right. For example, white light may also be added, and a most desirable photographing effect is achieved with white light being added.

It can be seen that, according to the method for controlling photographic fill-in light provided in this embodiment of the present invention, when a photographed object is at low illuminance, a display, located on a same side as a photographing apparatus, on a terminal may be controlled to add light to the photographed object, so as to improve a photographing effect of the photographing apparatus. Moreover, a preview image is turned into a complementary color, and after being turned into the complementary color, the preview image illuminates the photographed object, so as to provide a more distinct preview image to help compose an image.

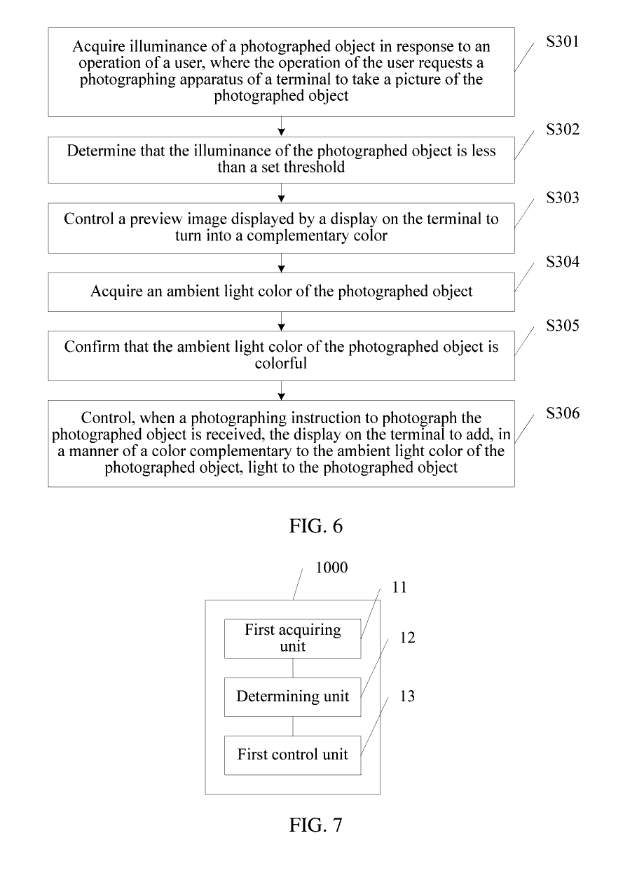

Referring to FIG. 6, FIG. 6 is a flowchart of still another method for controlling photographic fill-in light according to an embodiment of the present invention. The method includes the following.

Step S301: Acquire illuminance of a photographed object in response to an operation of a user, where the operation of the user requests a photographing apparatus of a terminal to take a picture of the photographed object.

Step S302: Determine that the illuminance of the photographed object is less than a set threshold.

Step S301 and step S302 are the same as step S101 and step S102 in the foregoing embodiment respectively, and details are not described herein again.

Step S303: Control a preview image displayed by a display on the terminal to turn into a complementary color.

Step S303 is the same as step S203 in the foregoing embodiment, and details are not described herein again.

Step S304: Acquire an ambient light color of the photographed object.

Step S305: Confirm that the ambient light color of the photographed object is colorful.

Step S306: Control, when a photographing instruction to photograph the photographed object is received, the display on the terminal to add, in a manner of a color complementary to the ambient light color of the photographed object, light to the photographed object.

A color of an ambient environment is reflected to a photographed object, which is referred to as an ambient light color of the photographed object. For example, when a picture of a person is being taken, the photographed person stands among green leaves, and the face of the person turns green. If the photographed person stands among red flowers, the face of the person also turns red. Obviously, in actual photographing, the ambient light color of the photographed object easily causes a color cast of the photographed object. For example, the photographed person is in an occasion such as a bar or a coffeehouse, and in such an occasion, solid-color light such as red light and green light or non-white light is usually used for lighting. A picture taken in this case also turns red or green.

An RGB color mode is a color standard in the industry, and is to obtain various colors by changing three color channels: red (R), green (G), and blue (B) and overlapping among the three color channels, where an RGB represents colors of three channels: red, green, and blue. This standard almost includes all colors perceptible to human vision.

For an LCD of 24 bits, an RGB configuration is (eight bits, eight bits, and eight bits). A complementary color is a color that turns white when overlapping with an original color, that is, a complementary color is obtained by subtracting an original color from white (RGB: 255, 255, 255). For example, a complementary color of red (RGB: 255, 0, 0) is cyan (0, 255, 255).

An ambient light color of the photographed object is acquired and it is confirmed that the ambient light color of the photographed object is colorful. Specifically, when the photographing apparatus in this embodiment of the present invention is used to preview an image, a mean value of colors of multiple pixels in a preview image is calculated to obtain an ambient light color. For example, three points (P1, P2, P3) are taken, and RGBs of the three points are:

P1 (R1=212, G1=16, B1=100), P2 (R2=210, G2=13, B2=105), and P3 (R3=220, G3=16, B3=95) respectively.

Therefore, an ambient light color is:

P=(R1+R2+R3)/3,(G1+G2+G3)/3,(B1+B2+B3)/3=(R=214,G=15,B=100).

In this embodiment of the present invention, a display on a terminal is controlled to add, in a manner of a color complementary to an ambient light color of a photographed object, light to the photographed object, so as to implement that a photographing effect is basically the same as that in white light and avoid a case of a severe color cast. For example, when a user is in an environment of green light, light may be added by using colors red+blue, which actually may achieve an effect of white light. A specific implementation manner may also be that, by setting an ISP parameter, a backlight source behind a display is controlled to emit light according to the set ISP parameter, thereby implementing a complementary color.

It can be seen that, according to the method for controlling photographic fill-in light provided in this embodiment of the present invention, when a photographed object is at low illuminance, a display, located on a same side as a photographing apparatus, on a terminal may be controlled to add light to the photographed object, so as to prevent a color cast and improve a photographing effect of the photographing apparatus. Moreover, a preview picture is turned into a complementary color, and after being turned into the complementary color, the preview picture illuminates the photographed object, so as to provide a more distinct preview picture to help compose an image.

Referring to FIG. 7, FIG. 7 is a schematic structural diagram of an apparatus for controlling photographic fill-in light according to an embodiment of the present invention. The apparatus 1000 includes a first acquiring unit 11, configured to acquire illuminance of a photographed object in response to an operation of a user, where the operation of the user requests a photographing apparatus of a terminal to take a picture of the photographed object.

Two photographing apparatuses are generally installed on an existing terminal such as a mobile phone and a tablet computer, where one photographing apparatus is disposed on a same side as a display of the terminal and is generally referred to as a front-facing camera. Generally, there is no strobe light disposed for the photographing apparatus, and in a case of low illuminance, a photographing effect of the photographing apparatus is relatively undesirable. Illuminance is a degree to which an object is illuminated, and specifically, refers to energy of visible light received on a unit area of an object. A street in the dark, a dimly lit room, and the like are generally of low illuminance. If illuminance of a photographed object is relatively low, when the photographed object is photographed by using the photographing apparatus, a picture of the photographed object is indistinct, and an effect is relatively undesirable. Moreover, because a photographing apparatus is located on a same side as a display, a behavior of photographing a photographed object by using the photographing apparatus is generally a behavior of taking a self-portrait photograph.

The user performs an operation on the terminal, for example, opens an application program having a photographing function to request the photographing apparatus of the terminal to take a picture of the photographed object, and the first acquiring unit 11 receives the operation of the user, and acquires illuminance of the photographed object in response to the operation of the user. Specifically, to acquire the illuminance of the photographed object by the first acquiring unit 11, a photoelectric sensor on the terminal may be used to detect the illuminance of the photographed object.

A determining unit 12 is configured to determine that the illuminance of the photographed object is less than a set threshold.

The set threshold of the illuminance is preset in the terminal, and when the illuminance of the photographed object is less than the set threshold, it is determined that the photographed object is at low illuminance.

A first control unit 13 is configured to control, when a photographing instruction to photograph the photographed object is received, a display on the terminal to add, in a set manner, light to the photographed object.

The photographing apparatus and the display are located on a same side.

The display on the terminal is generally a liquid crystal display (Liquid Crystal Display, LCD). The LCD is a substance between a solid state and a liquid state and cannot emit light by itself, and with the aid of an additional backlight source, the LCD can emit light. When the photographing apparatus is used for photographing, because the terminal is relatively close to the photographed object, generally, less than 30 cm, light emitted by the LCD may illuminate the photographed object. The display on the terminal is controlled to add, in a set manner, light to the photographed object, so that a photographing effect of the photographing apparatus can be improved. As shown in FIG. 2, light emitted by an LCD screen of a mobile phone illuminates a human face of which a self-portrait photograph is to be taken, and the human face reflects sufficient light to a front-facing camera on the mobile phone, so that a relatively distinct image is formed in the front-facing camera.

Preferably, although in this embodiment of the present invention, a front-facing camera is used as an example for description, and the so-called “front-facing” does not represent a limitation to an application scope of this embodiment of the present invention. A display can be used to add light as long as a camera or a photographing apparatus is located on a same side as the display. Preferably, this embodiment of the present invention may be applied to a scenario in which a camera is not configured with a strobe light. However, this embodiment of the present invention may also be applicable to a scenario in which a strobe light is provided. In this way, with both a strobe light and a display to add light, a photographing effect is more desirable.

It can be seen that, according to the apparatus for controlling photographic fill-in light provided in this embodiment of the present invention, when a photographed object is at low illuminance, a display, located on a same side as a photographing apparatus, on a terminal may be controlled to add light to the photographed object, so as to improve a photographing effect of the photographing apparatus.

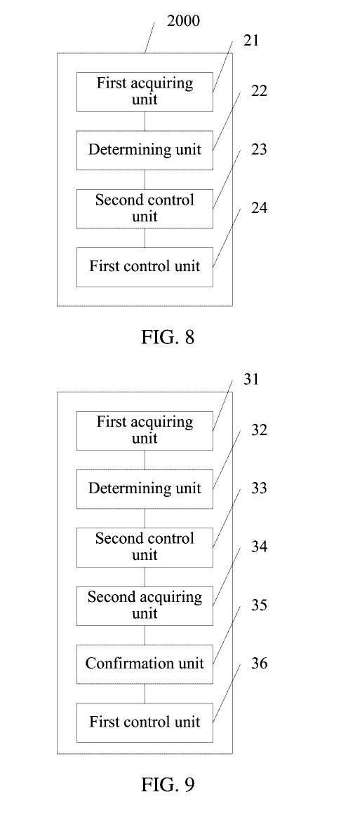

Referring to FIG. 8, FIG. 8 is a schematic structural diagram of another apparatus for controlling photographic fill-in light according to an embodiment of the present invention. The apparatus 2000 includes a first acquiring unit 21, configured to acquire illuminance of a photographed object in response to an operation of a user, where the operation of the user requests a photographing apparatus of a terminal to take a picture of the photographed object, a determining unit 22 is configured to determine that the illuminance of the photographed object is less than a set threshold, where functions of the first acquiring unit 21 and the determining unit 22 are the same as those of the first acquiring unit 11 and the determining unit 12 in the foregoing embodiment respectively, and details are not described herein again, and a second control unit 23, configured to control a preview image displayed by a display on the terminal to turn into a complementary color.

Before formal photographing is performed by using the photographing apparatus on the terminal, generally, a preview image of the photographed object is previewed on the display of the terminal. However, as shown in the left figure of FIG. 4, at low illuminance, because light is weak, the preview image is usually dark. A user of the terminal cannot accurately see the preview image clearly and therefore cannot determine an image composition situation of the photographed object, resulting in a case in which the photographed object, for example, a human face, is not in the middle of an image. When it is determined that the illuminance of the photographed object is less than a set threshold, the second control unit 23 may control a preview image displayed by the display on the terminal to turn into a complementary color. Because before being turned into a complementary color, a photographed preview image is dark, and after being turned into the complementary color, a preview image is displayed to be approximately white, the photographed object can be illuminated, so that the user can clearly see image composition of the photographed object from the preview image.

An image signal processing (Image Signal Processing, ISP) module is integrated in all existing terminal platforms; therefore, for an effect of a preview complementary color, an ISP parameter may be directly set, and a backlight source is controlled to emit light according to the set ISP parameter to implement a complementary color. A method for specifically setting the ISP parameter belongs to the prior art, and details are not described herein again.

A first control unit 24 is configured to control, when a photographing instruction to photograph the photographed object is received, the display on the terminal to add, in a set manner, light to the photographed object.

The first control unit 24 is specifically configured to control an entire display area or a partial display area of the display to add light to the photographed object.

When formal photographing is performed on the photographed object, the first control unit 24 may control an entire display area or a partial display area of the display to add light to the photographed object. The entire display area of the display is controlled to add light, for example, white light may be added. For example, as shown in FIG. 5a, an LCD display of a mobile phone is used to add pure white light. Light rays emitted by a pure white LCD display are the strongest and an area, which is illuminated by the pure white LCD display, of the photographed object is the largest. The partial display area of the display is controlled to add light. For example, as shown in FIG. 5b, because the LCD display of the mobile phone may be further controlled to display different pictures, the LCD display is controlled to display four different pictures shown in FIG. 5b, thereby implementing adding light to the photographed object in different directions of the top, bottom, left, and right. For example, white light may also be added, and a most desirable photographing effect is achieved with white light being added.

It can be seen that, according to the apparatus for controlling photographic fill-in light provided in this embodiment of the present invention, when a photographed object is at low illuminance, a display, located on a same side as a photographing apparatus, on a terminal may be controlled to add light to the photographed object, so as to improve a photographing effect of the photographing apparatus. Moreover, a preview image is turned into a complementary color, and after being turned into the complementary color, the preview image illuminates the photographed object, so as to provide a more distinct preview image to help compose an image.

Referring to FIG. 9, FIG. 9 is a schematic structural diagram of still another apparatus for controlling photographic fill-in light according to an embodiment of the present invention. The apparatus 3000 includes a first acquiring unit 31, configured to acquire illuminance of a photographed object in response to an operation of a user, where the operation of the user requests a photographing apparatus of a terminal to take a picture of the photographed object. The apparatus 3000 further includes a determining unit 32 configured to determine that the illuminance of the photographed object is less than a set threshold, where functions of the first acquiring unit 31 and the determining unit 32 are the same as those of the first acquiring unit 11 and the determining unit 12 in the foregoing embodiment respectively, and details are not described herein again, and a second control unit 33, configured to control a preview image displayed by a display on the terminal to turn into a complementary color.

A function of the second control unit 33 is the same as that of the second control unit 23 in the foregoing embodiment, and details are not described herein again.

A second acquiring unit 34 is configured to acquire an ambient light color of the photographed object.

A confirmation unit 35 is configured to confirm that the ambient light color of the photographed object is colorful.

A first control unit 36 is configured to control, when a photographing instruction to photograph the photographed object is received, the display on the terminal to add, in a set manner, light to the photographed object.

The first control unit 36 is specifically configured to control the display on the terminal to add, in a manner of a color complementary to the ambient light color of the photographed object, light to the photographed object.

A color of an ambient environment is reflected to a photographed object, which is referred to as an ambient light color of the photographed object. For example, when a picture of a person is being taken, the photographed person stands among green leaves, and the face of the person turns green. If the photographed person stands among red flowers, the face of the person also turns red. Obviously, in actual photographing, the ambient light color of the photographed object easily causes a color cast of the photographed object. For example, the photographed person is in an occasion such as a bar or a coffeehouse, and in such an occasion, solid-color light such as red light and green light or non-white light is usually used for lighting. A picture taken in this case also turns red or green.

An RGB color mode is a color standard in the industry, and is to obtain various colors by changing three color channels: red (R), green (G), and blue (B) and overlapping among them, where an RGB represents colors of three channels: red, green, and blue. This standard almost includes all colors perceptible to human vision.

For an LCD of 24 bits, an RGB configuration is (eight bits, eight bits, and eight bits). A complementary color is a color that turns white when overlapping with an original color, that is, a complementary color is obtained by subtracting an original color from white (RGB: 255, 255, 255). For example, a complementary color of red (RGB: 255, 0, 0) is cyan (0, 255, 255).

The second acquiring unit 34 acquires an ambient light color of the photographed object, and the confirmation unit 35 confirms that the ambient light color of the photographed object is colorful. Specifically, when the photographing apparatus in this embodiment of the present invention is used to preview an image, a mean value of colors of multiple pixels in a preview image is calculated to obtain an ambient light color.

For example, three points (P1, P2, P3) are taken, and RGBs of the three points are:

P1 (R1=212, G1=16, B1=100), P2 (R2=210, G2=13, B2=105), and P3 (R3=220, G3=16, B3=95) respectively.

Therefore, an ambient light color is:

P=(R1+R2+R3)/3,(G1+G2+G3)/3,(B1+B2+B3)/3=(R=214,G=15,B=100).

In this embodiment of the present invention, the first control unit 36 controls a display on a terminal to add, in a manner of a color complementary to an ambient light color of a photographed object, light to the photographed object, so as to implement that a photographing effect is basically the same as that in white light and avoid a case of a severe color cast. For example, when a user is in an environment of green light, light may be added by using colors red+blue, which actually may achieve an effect of white light. A specific implementation manner may also be that, by setting an ISP parameter, a backlight source behind a display is controlled to emit light according to the set ISP parameter, thereby implementing a complementary color.

It can be seen that, according to the apparatus for controlling photographic fill-in light provided in this embodiment of the present invention, when a photographed object is at low illuminance, a display, located on a same side as a photographing apparatus, on a terminal may be controlled to add light to the photographed object, so as to prevent a color cast and improve a photographing effect of the photographing apparatus. Moreover, a preview picture is turned into a complementary color, and after being turned into the complementary color, the preview picture illuminates the photographed object, so as to provide a more distinct preview picture to help compose an image.

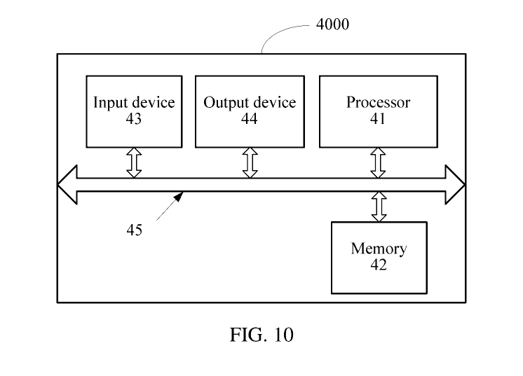

Referring to FIG. 10, FIG. 10 is a schematic structural diagram of a terminal according to an embodiment of the present invention. The terminal 4000 includes a processor 41, a memory 42, an input device 43, an output device 44, and a bus system 45.

The processor 41 may be further referred to as a central processing unit (Central Processing Unit, CPU). The processor 41 may be an integrated circuit chip and has a signal processing capability. The processor 41 may be a general purpose processor, a digital signal processor (Digital Signal Processor, DSP), an application-specific integrated circuit (Application Specific Integrated Circuit, ASIC), a field programmable gate array (Field Programmable Gate Array, FPGA), or another programmable logical device, discrete gate or transistor logical device, or discrete hardware component. A general purpose processor may be a microprocessor or the processor may be any conventional processor and the like.

The memory 42 may include a read-only memory and a random access memory, and provides an instruction and data to the processor 41. A part of the memory 42 may further include a non-volatile random access memory (NVRAM).

All components of the terminal 4000 are coupled by using the bus system 45. The bus system may be an industry standard architecture (Industry Standard Architecture, ISA) bus, a peripheral component interconnect (PCI) bus, an extended industry standard architecture (EISA) bus, or the like. The bus may be one or more physical lines, and when it is multiple physical lines, it may be classified into an address bus, a data bus, a control bus, and the like. In some other embodiments of the present invention, the processor 41, the memory 42, the input device 43, and the output device 44 may also be directly connected by using communications lines.

The input device 43 may be specifically implemented as a mouse, a keyboard, a microphone, or the like, and the output device 44 may be specifically implemented as a display, an audio device, or a video device. Certainly, functions of the input device 43 and the output device 44 may also be implemented by using an input/output device, for example, implemented as a touchscreen.

The processor 41 reads a computer program in the memory 42 to perform acquiring illuminance of a photographed object in response to an operation of a user, where the operation of the user requests a photographing apparatus of the terminal to take a picture of the photographed object, determining that the illuminance of the photographed object is less than a set threshold, and controlling, when a photographing instruction to photograph the photographed object is received, a display on the terminal to add, in a set manner, light to the photographed object. The photographing apparatus and the display are located on a same side.

As an implementation manner, the step of performing, by the processor 41, controlling the display on the terminal to add, in a set manner, light to the photographed object includes controlling an entire display area or a partial display area of the display to add light to the photographed object. As another implementation manner, the step of performing, by the processor 41, controlling an entire display area or a partial display area of the display to add light to the photographed object includes controlling the entire display area or the partial display area of the display to add white light to the photographed object.

As still another implementation manner, before performing the step of controlling the display on the terminal to add, in a set manner, light to the photographed object, the processor 41 further performs the following steps acquiring an ambient light color of the photographed object, and confirming that the ambient light color of the photographed object is colorful. The step of performing, by the processor, the step of controlling the display on the terminal to add, in a set manner, light to the photographed object includes controlling the display on the terminal to add, in a manner of a color complementary to the ambient light color of the photographed object, the light to the photographed object.

As still another implementation manner, after performing the step of determining that the illuminance of the photographed object is less than a set threshold, and before performing the step of receiving the photographing instruction to photograph the photographed object, the processor 41 further performs the following step controlling a preview image displayed by the display on the terminal to turn into a complementary color.

It can be seen that, according to the terminal provided in this embodiment of the present invention, when a photographed object is at low illuminance, a display, located on a same side as a photographing apparatus, on the terminal may be controlled to add light to the photographed object, so as to improve a photographing effect of the photographing apparatus.

It should be noted that, for ease of description, the foregoing method embodiments are described as a series of action combinations. However, a person skilled in the art should understand that the present invention is not limited to the described sequence of the actions, because some steps may be performed in another sequence or performed at the same time according to the present invention. In addition, a person skilled in the art should also understand that all the embodiments described in this specification belong to exemplary embodiments, and the involved actions and modules are not necessarily mandatory to the present invention.

In the foregoing embodiments, the description of each embodiment has respective focuses. For a part that is not described in detail in an embodiment, refer to related descriptions in other embodiments.

With descriptions of the foregoing embodiments, a person skilled in the art may clearly understand that the present invention may be implemented by hardware, firmware or a combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. The computer-readable medium may include, for example, but is not limited to, a random access memory (Random Access Memory, RAM), a read-only memory (Read-Only Memory, ROM), an electrically erasable programmable read-only memory (Electrically Erasable Programmable Read-Only Memory, EEPROM), a compact disc read-only memory (Compact Disc Read-Only Memory, CD-ROM), another compact disc or magnetic disk storage medium, another magnetic storage device, or any other medium that can be used to carry or store expected program code having an instruction or data structure form and that can be stored and accessed by a computer. In addition, any connection may be appropriately defined as a computer-readable medium. For example, if software is transmitted from a website, a server or another remote source by using a coaxial cable, an optical fiber/cable, a twisted pair, a digital subscriber line (Digital Subscriber Line, DSL for short) or wireless technologies such as infrared ray, radio and microwave, the coaxial cable, optical fiber/cable, twisted pair, DSL or wireless technologies such as infrared ray, radio and microwave are included in fixation of a medium to which they belong. For example, a disk (Disk) and disc (disc) used by the present invention includes a compact disc (CD), a laser disc, an optical disc, a digital versatile disc (DVD), a floppy disk and a Blu-ray disc, where the disk generally copies data by a magnetic means, and the disc copies data optically by a laser means. The foregoing combination should also be included in the protection scope of the computer-readable medium.

In summary, what is described above is merely exemplary embodiments of the technical solutions of the present invention, but is not intended to limit the protection scope of the present invention. Any modification, equivalent replacement, or improvement made without departing from the spirit and principle of the present invention shall fall within the protection scope of the present invention.

1-15. (canceled)

16. A method for controlling photographic fill-in light, wherein the method comprises:
acquiring illuminance of a photographed object in response to an operation of a user, wherein the operation of the user requests a photographing apparatus of a terminal to take a picture of the photographed object;
determining that the illuminance of the photographed object is less than a set threshold; and
controlling, when a photographing instruction to photograph the photographed object is received, a display on the terminal to add, in a set manner, light to the photographed object;
wherein the photographing apparatus and the display are located on a same side of the terminal.

17. The method according to claim 16, wherein the controlling a display on the terminal to add light to the photographed object comprises:
controlling an entire display area or a partial display area of the display to add the light to the photographed object.

18. The method according to claim 17, wherein the light added to the photographed object comprises white light.

19. The method according to claim 16, wherein the method further comprises performing, before the controlling a display on the terminal to add light to the photographed object:
acquiring an ambient light color of the photographed object; and
wherein the controlling a display on the terminal to add light to the photographed object comprises performing, in response to the ambient light color of the photographed object being colorful:
controlling the display on the terminal to add, in a manner of a color complementary to the ambient light color of the photographed object, the light to the photographed object.

20. The method according to claim 16, wherein the method further comprises performing, after the determining that the illuminance of the photographed object is less than a set threshold and before the photographing instruction to photograph the photographed object is received:
controlling a preview image displayed by the display on the terminal to turn into a complementary color.

21. A terminal, comprising:
an input apparatus;
an output apparatus
a memory; and
a processor coupled to the memory,
wherein the output apparatus comprises a display; and
wherein the processor is configured to:
acquire illuminance of a photographed object in response to an operation of a user, wherein the operation of the user requests a photographing apparatus of the terminal to take a picture of the photographed object;
determine that the illuminance of the photographed object is less than a set threshold; and
control, in response to a photographing instruction to photograph the photographed object being received, the display on the terminal to add, in a set manner, light to the photographed object;
wherein the photographing apparatus and the display are located on a same side of the terminal.

22. The terminal according to claim 21, wherein the controlling the display on the terminal to add light to the photographed object comprises:
controlling an entire display area or a partial display area of the display to add the light to the photographed object.

23. The terminal according to claim 22, wherein the light added to the photographed object comprises white light.

24. The terminal according to claim 21, wherein the processor is further configured to, before controlling the display on the terminal to add light to the photographed object:
acquire an ambient light color of the photographed object; and
wherein the controlling the display on the terminal to add, in a set manner, light to the photographed object comprises performing, in response to the ambient light color of the photographed object being colorful:
controlling the display on the terminal to add, in a manner of a color complementary to the ambient light color of the photographed object, the light to the photographed object.

25. The terminal according to claim 21, wherein the processor is further configured to, after determining that the illuminance of the photographed object is less than a set threshold and before the photographing instruction to photograph the photographed object is received:
control a preview image displayed by the display on the terminal to turn into a complementary color.

26. A terminal, comprising:
a photographing apparatus;
a display disposed on a same side of the terminal as the photographing apparatus;
a processor; and
a non-transitory computer-readable storage medium storing a program to be executed by the processor, the program including instructions to:
acquire illuminance of a photographed object in response to an operation of a user, wherein the operation of the user requests that the photographing apparatus of the terminal to take a picture of the photographed object;
determine that the illuminance of the photographed object is less than a set threshold;
control, in response to receiving a photographing instruction to photograph the photographed object, the display on the terminal to provide a displayed element that projects, in a set manner, light onto the photographed object;
cause the photographing apparatus to take the picture while the display on the terminal provides the displayed element.

27. The terminal according to claim 26, wherein the instructions to control the display on the terminal comprise instructions to:
controlling an entire display area or a partial display area of the display to project the light onto the photographed object.

28. The terminal according to claim 27, wherein the light projected onto the photographed object comprises white light.

29. The terminal according to claim 26, wherein the instructions to control the display on the terminal comprise instructions to:
acquire an ambient light color of the photographed object; and
control the display on the terminal to project light having a color that is complementary to the acquired ambient light color onto the photographed object.

30. The terminal according to claim 26, control, wherein the instructions to control the display on the terminal to provide a displayed element includes instructions to:
control a preview image displayed by the display on the terminal to turn into a complementary color.
